(19) United States
(12) Patent Application Publication
(10) Pub. No.: US 2007/0165310 A1
(43) Pub. Date: Jul. 19, 2007

(54) Variable reflectivity coatings with constant optical thickness and phase

(75) Inventor: Ricky K. Nubling, Santa Rosa, CA (US)

Correspondence Address: MORRISON & FOERSTER LLP, 1650 TYSONS BOULEVARD, SUITE 400, MCLEAN, VA, 22102, US

(73) Assignee: Essex Corporation, Columbia, MD (US)

(21) Appl. No.: 11/502,631

(22) Filed: Aug. 11, 2006

Related U.S. Application Data
(60) Provisional application No. 60/707,545, filed on Aug. 12, 2005.

(51) Int. Cl. G02B 1/10

(52) U.S. Cl. 359/584

(57) ABSTRACT

A method of controlling phase on at least one of reflectance and transmission in an optic device. The optic device includes a multiple layer stack. At least one dimension of a first layer in the stack is varied in at least a first direction. At least one dimension of a second layer in the stack is varied in at least a second direction. The first direction and the second direction are substantially opposite. The stack is maintained at a substantially constant optical thickness.

### CROSS-REFERENCE TO RELATED APPLICATIONS

This application claims priority to U.S. Provisional Application No. 60/707,545, filed Aug. 12, 2005, for “Variable Reflectivity Coatings with Constant Optical Thickness and Phase.”

### BACKGROUND OF THE INVENTION

A traditional approach to creating a variable reflectivity using thin-film coatings would be to design an all-dielectric coating with a reflectance that varies in wavelength (as shown, for example, in FIG. 2 and FIG. 3). The thickness of all of the layers in the design are then varied by the same amount (as shown, for example, in FIG. 1a) using fixed or movable masking to shift the coating response up or down in wavelength. The reflectance at a fixed wavelength will vary as the coating shifts in wavelength, creating a controlled variable reflectivity. See, for example, C. Zizzo, C. Arnone, C. Cali, and S. Sciortino, “Fabrication and characterization of tuned Gaussian mirrors for the visible and the near infrared,” Opt. Lett. 13, 342-344 (1988).

An alternate approach to generating a variable reflectivity would be to vary a single layer of an all-dielectric design from an integral quarter-wave (QW) to an integral half-wave (HW) thickness (FIG. 1b). A quarter-wave is defined at the film thickness at which nd/λ=0.25, where n is the index of refraction of the layer, d is the physical thickness, and λ is the design wavelength. If the baseline design is a quarter-wave stack, and the variable layer is of the high-index material of that stack, and the variable layer varies by no more than a single quarter-wave, then the reflectance will vary monotonically by as much as 40%-50%. See, for example, G. Emilliani, A. Piegari, S. De Silvestri, P. Laporta, and V. Magni, “Optical coatings with variable reflectance for laser mirrors,” Appl. Opt. 28, 2832-2837 (1989); G Duplain, P. G. Verly, J. A. Dobrowolski, A. Waldorf, and S. Bussiere, “Graded-reflectance mirrors for beam quality control in laser resonators,” Appl. Opt. 32, 1145-1153 (1993); A. Piegari and G. Emilliani, “Laser mirrors with variable reflected intensity and uniform phase shift: design process,” Appl. Opt. 32, 5454-5461 (1993); A. Piegari, “Coatings with graded reflectance profile: conventional and unconventional characteristics,” Appl. Opt. 35, 5509-5519 (1996).

One problem with this approach is that it only yields a large reflectivity change for a maximum reflectivity below about 90-95%. If, for example, the design calls for a reflectivity change from 99.8% to 90% then this approach is inadequate. Varying just the last layer in the design would give a reflectivity change of only approximately 99.8%-99.3%. Furthermore, the concept of varying only one layer in the design suffers from the fact that the overall optical thickness will also vary (by one quarter-wave). For applications where this is significant, i.e. where the reflected and/or transmitted phase must be held constant, this approach would not work.

A single variable metal layer could also be used to create a reflectivity gradient, but absorption would be high, and the reflected and transmitted phase would vary dramatically for thin metal films varying in thickness. Variable metal films are typically used in neutral density filters where absorption is not critical.

### SUMMARY OF THE INVENTION

A method of making variable reflectivity optics having a controlled phase on reflection and transmission using all-dielectric thin film coatings. Two or more layers in the coating design may be varied in equal but opposite directions to maintain overall optical thickness of the coating. This has significant advantages when trying to maintain reflected and/or transmitted phase across the optic. Some examples are shown for a variable reflector designed around the telecom C-Band (1530-1570 nm). The concept is applicable to a wide variety of optical wavelengths, provided the thin-film materials used are transparent in the desired wavelength region.

### DESCRIPTION OF THE DRAWINGS

FIG. 1 is an illustration showing some examples of various gradient reflectivity approaches, including: (a) an example of varying the thickness of all layers, (b) an example of varying only the top layer, (c) an example of varying two or more layers in opposite directions, (d) another example of varying two or more layers in opposite directions.

FIG. 2 is an illustration showing an example of a variable reflectivity profile.

FIG. 3 is an illustration showing an example of a variable reflectivity coating concept, whereby all of the layers in the design are varied in thickness, at the thick end (solid curve) and at the thin end (dashed curve) of the coating.

FIG. 4 is an illustration showing an example of a variable reflectivity coating concept whereby two layers in the design are varied in opposite directions at the thick high-reflectivity end (solid curve) and at the thin low-reflectivity end (dashed curve) of the coating.

FIG. 5 is an illustration showing an example of relative film thickness variation for a proposed two-layer-varying design concept.

FIG. 6 is an illustration showing an example of an 18-layer design with two variable layers buried within a quarter-wave reflector stack.

FIG. 7 is an illustration showing an example of the embodiment of FIG. 6 at a position where the variable layers are integral half-wave thicknesses, illustrating an example of the concept of “absentee” layers.

FIG. 8 is an illustration showing an example of the spectral response of the embodiment shown in FIG. 6 at the position where the variable layers are integral half-waves in thickness (solid curve) as compared to a 6-layer quarter-wave reflector stack (dashed curve).

FIG. 9 is an illustration showing an example of phase shift on reflection (solid curve) and transmission (dashed curve) from coating of design concept 1(a) above whereby all of the layers in the design are varied in thickness.

FIG. 10 is an illustration showing an example of Phase shift on reflection (solid curve) and transmission (dashed curve) from coating of design concept 1 (d) above whereby two layers are varied in opposite directions.

### DETAILED DESCRIPTION OF THE INVENTION

In a preferred embodiment, a single layer of an all-dielectric design may be changed by no more than one quarter-wave optical thickness. A second layer of the same material is also varied in approximately equal but opposite direction to maintain the overall optical thickness across the optic. By varying two (or more) layers in equal but opposite directions the response remains centered about the design wavelength.

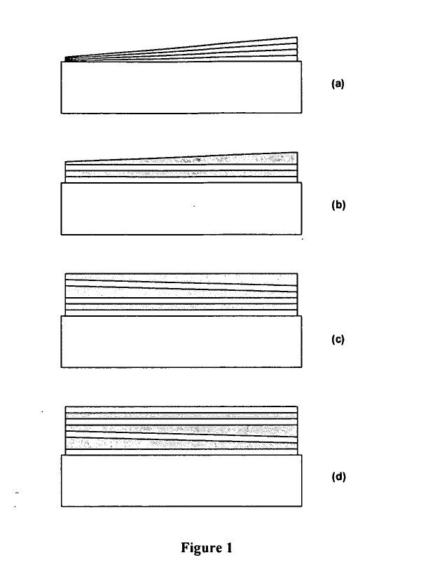

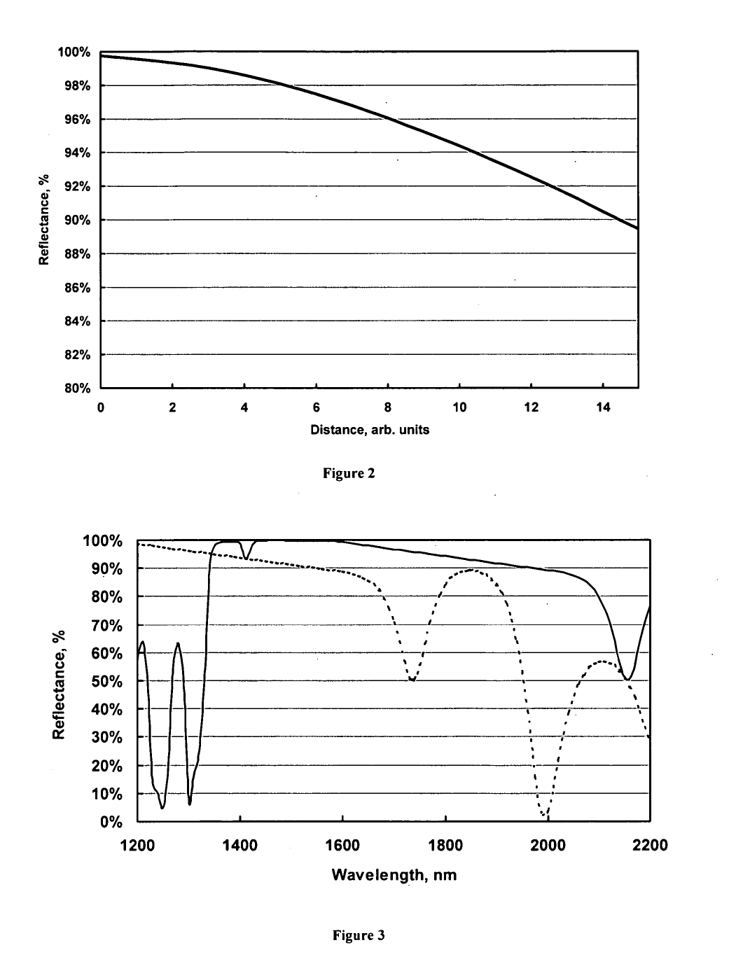

As shown schematically in FIGS. 1c and d, for example, these two variable layers can be placed near the substrate interface, the air interface, or in the middle of the design. The remaining layers may be held to a constant quarter-wave optical thickness. The number of quarter-wave layer pairs will determine the maximum reflectivity of the optic; e.g., approximately 9 layer pairs (of SiO₂ and Nb₂O₅) may be used to generate a maximum reflectivity of 99.85%. FIG. 5 is an illustration showing an example of what the relative thickness of the two variable layers might look like.

By keeping the overall optical thickness substantially constant—or nearly substantially constant for cases where a particular gradient specification necessitates that the two variable layer thicknesses not be exactly equal in amplitude while still remaining opposite in direction—the transmitted phase should remain substantially constant even across the gradient. The top few layers of a reflector stack tend to dominate reflected phase, so to keep reflected phase constant the variable layers are preferably moved away from the air interface.

Varying two layers of a quarter-wave reflector stack in this manner may suffer from a lack of reflectivity change for designs where the maximum reflectivity is above 90%-95%. One is limited to the change in reflectivity associated with changing a single layer by no more than one quarter-wave optical thickness. One solution to overcome this limitation is to use a relatively higher index material, such as silicon, for the two variable layers. The remainder of the reflector stack could be formulated using this same higher index material together with a lower index material (SiO₂/Si, for example). However, in the case of a device intended to operate at 1530-1570 nm the absorption may be too high. Therefore, this higher index material (Si in this example) is preferably used only for the two variable layers. The base reflector stack is designed with lower-absorbing materials (such as SiO₂ and Nb₂O₅ for 1550 nm), thereby making the small absorption introduced by the two variable silicon layers tolerable.

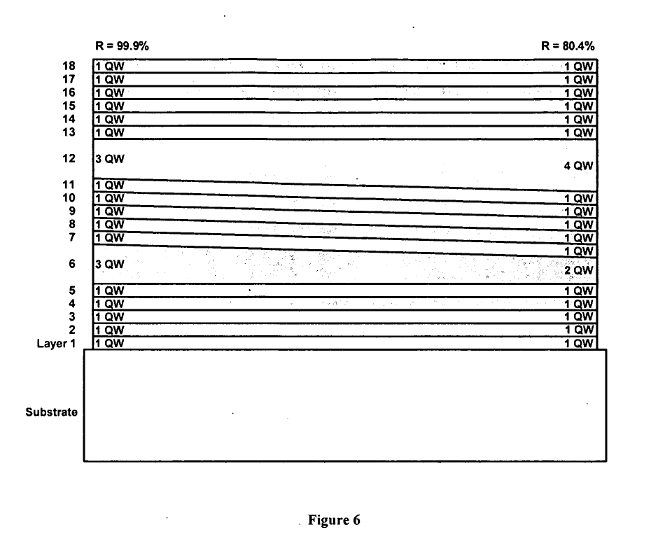

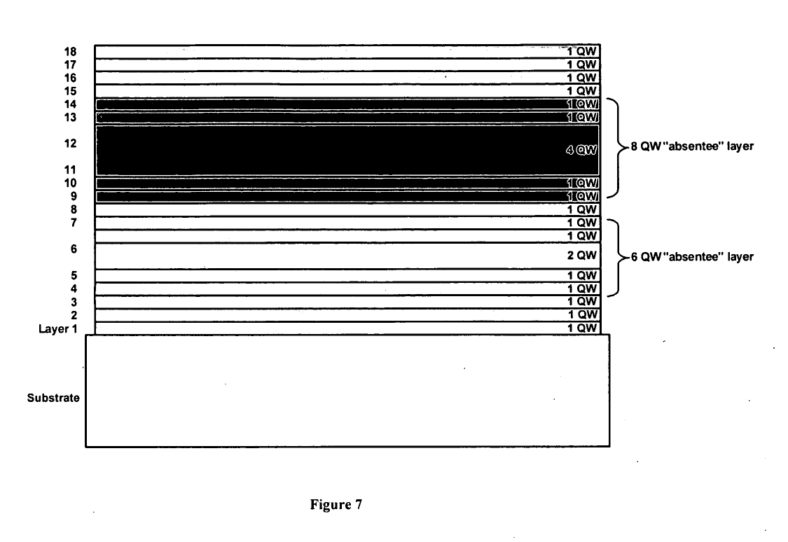

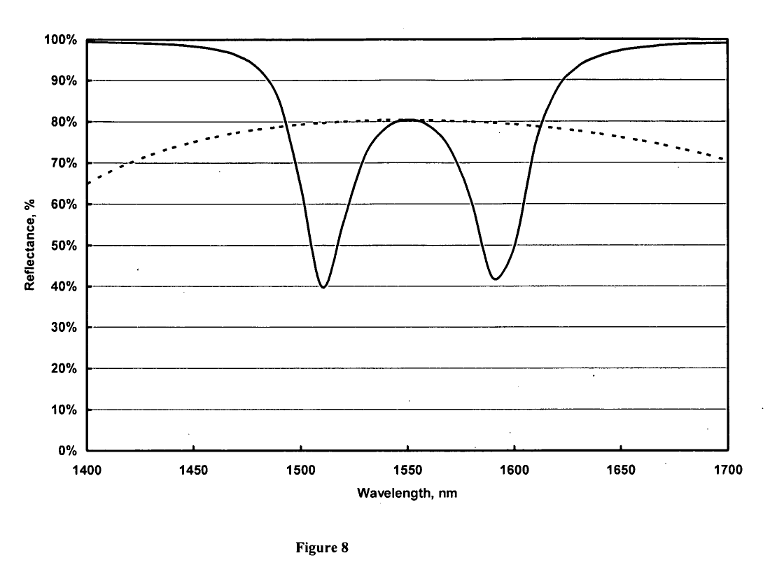

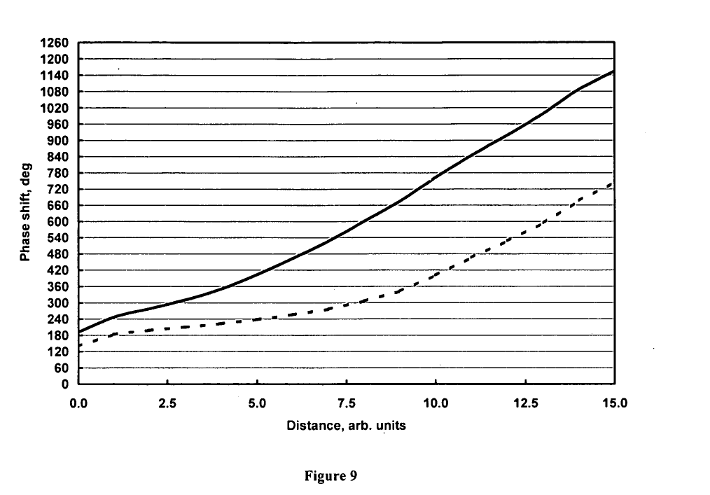

In an alternative embodiment the variable layers may be placed at or near the center of the reflector stack rather than at or near the substrate or air interfaces. In this manner it is possible to achieve larger reflectivity changes without using the higher-index silicon film. Consider, for example, the 18-layer quarter-wave design of alternating low-index and high-index films shown in FIG. 6. Layers 6 and 12 are varied from 3 QW to 2 QW and 4 QW, respectively. This embodiment has a maximum reflectance when both variable layers are integral QW thick (3 QW in this example) and a minimum reflectance when they are integral HW thick (2 and 4 QW in this example). When both layers are integral half-wave HW optical thickness they effectively become “absentee” layers. That is, the response at the embodiment wavelength is as if the layers were of zero thickness. Additionally, the single QW layers on either side of this integral HW layer, being of the same index of refraction, become effectively a 2 QW absentee layer themselves. If this is followed through for this embodiment (see FIG. 7), the resulting embodiment behaves like a 6 QW reflector stack at the design wavelength (FIG. 8). If these variable layers are at the substrate or air interface, then three absentee layers and an 18-layer quarter-wave reflector stack effectively becomes a 14-layer reflector stack. The two quarter-wave low-index films on either side of a half-wave high index layer would effectively become a half-wave absentee layer. Thus, placing the two variable layers appropriately in the center of the reflector stack can create multiple absentee layers, so that an 18-layer quarter-wave reflector stack can effectively become a 12, 10, or 8-layer reflector stack.

In an alternative embodiment the low-index material may be varied instead of the high-index material. The gradient reflectivity specification will indicate which material should preferably be varied. In most cases, varying the high index material will be the preferable approach. The concept is not limited to varying just two layers. Three or more layers could be varied to meet particular design requirements, with the total optical thickness being maintained to minimize phase errors.

The concept enables the reflected and transmitted phase to be held constant across the gradient. FIG. 6 and FIG. 7 illustrate examples of this. FIG. 6 is an illustration showing the reflected and transmitted phase shift from a traditional variable reflector design whereby all of the layers are varied in thickness. Note that the phase shift on reflection or transmission goes through several cycles of 360 degrees. This is due to the fact that there is a large change in optical thickness associated with this design approach.

In contrast, FIG. 7 shows an example of reducing the phase shift on reflectance to almost a constant 180 degrees and the phase shift on transmission to approximately +/−20 degrees. The phase shift on transmission could also be held constant by keeping the thickness variation of the two layers exactly equal but opposite, but this will depend on the desired reflectivity profile.

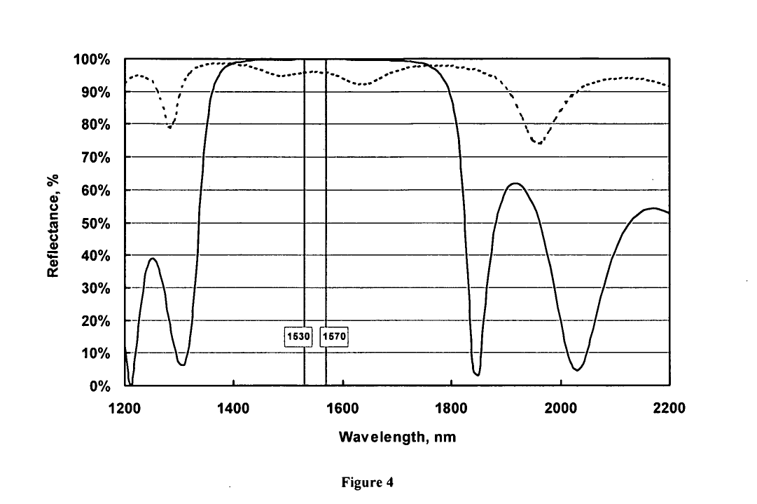

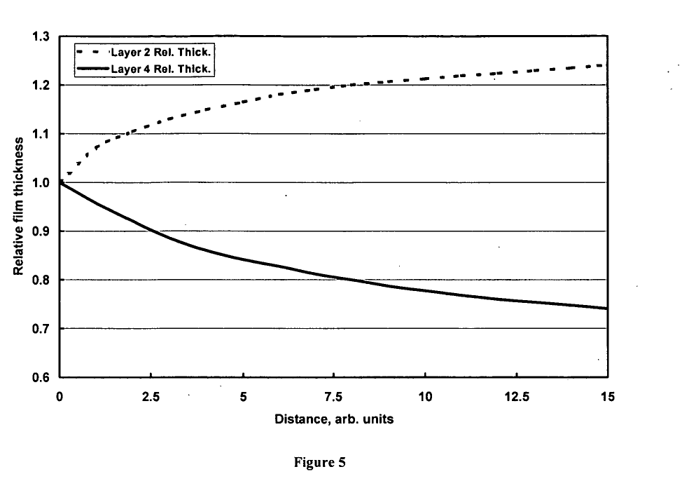

The invention enables a more constant reflectivity across a wavelength. The typical approach of varying all of the layers in a design necessitates a coating having a spectral slope, i.e. the coating must vary in wavelength by design. Even the design concept whereby a single layer is varied will generate the appropriate gradient profile only over a very small wavelength range. The invention allows us to get much more constant reflectivity across a range of wavelengths (1530-1570 nm, for example with the design shown in FIG. 4), since the bulk of the design is simply a uniform-thickness, quarter-wave stack. Using films with a high index ratio, i.e. SiO₂ and Si, would extend the operable wavelength range even further.

The invention enables easier manufacture. Once appropriate masking is in place, it is much easier to control the thickness of just two layers in a quarter-wave design rather than having to control the thickness of each layer in a complicated non-quarter-wave design.

It may be difficult to achieve large reflectivity changes over a small distance. Also, using a high-index film such as silicon may limit the wavelength range of use to greater than approximately 1500 nm. Nevertheless, by placing the variable layers in the center of a reflector stack (as described above) a large reflectivity change may be achieved without the use of silicon in the film.

This invention could be used in any optical system that requires an optic with a variable reflectivity such as output couplers for unstable laser resonators or for etalons to minimize frequency shifts due to material dispersion. See, for example, Q. Zhang, “Etalons with variable reflectivity,” U.S. Pat. No. 6,621,614 B1 (2003) (incorporated herein by reference).

Another specific area of use is as part of a Hyperfine device (such as those manufactured by Essex Corporation of Columbia, Md.), which consists of an etalon having a constant reflectivity (>99.95%) on one end of the cavity and a variable reflectivity (potentially 99.9%-70%) on the other end of the cavity. See, for example, T. Turpin, F. Froehlich, D. Nichols, “Optical taped delay line,” U.S. Pat. No. 6,608,721 B1 (2003) (incorporated herein by reference). The etalon may be solid or air-spaced. In the case of an air-spaced etalon, the uniform high reflector and gradient coatings may be placed on different substrates. In such embodiment, an input beam will be reflected back and forth through the etalon, so that the reflected and transmitted phase shifts from each bounce become critical. The invention allows for at least an order of magnitude better phase control.

A variable reflectivity film having over a 60-mm aperture is currently being manufactured using the present invention.

Although various QW embodiments are disclosed herein, the invention is not limited to QW embodiments. The invention is equally applicable to QW embodiments and non-QW embodiments.

The invention is not limited to embodiments optimized for constant phase across the aperture. The invention is equally applicable to embodiments in which something other than constant phase is desired. The invention may be used in embodiments intended to match a phase response across the aperture to a particular profile.

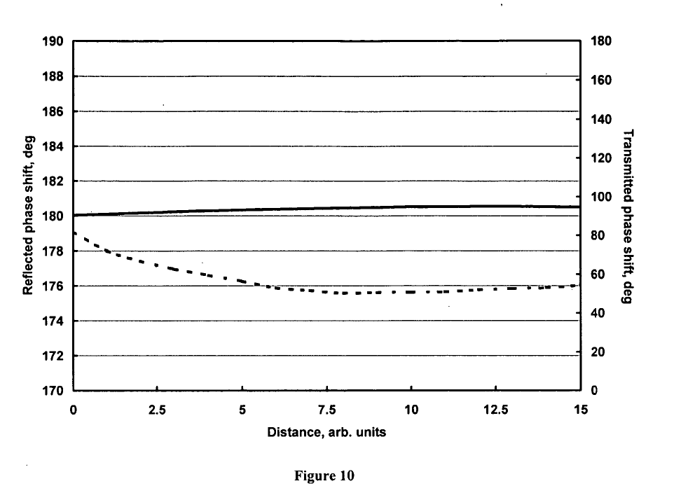

A preferred embodiment may provide even better phase control across the aperture. Varying two layers in equal but opposite directions gives a spectral response that is centered about the design wavelength and keeps both reflected and transmitted phases nearly constant across the aperture (see FIG. 10). By further varying the bottom layer (at the substrate/film interface) to control transmitted phase and the top (at the film/air interface) to control reflected phase, the phase variation across the aperture at the design wavelength may theoretically be reduced to zero everywhere.

In a preferred embodiment the invention maintains a substantially constant phase across the aperture. This is achieved in a preferred embodiment by maintaining a constant optical thickness. Because phase is cyclical (0-2 pi), it is possible to have constant phase without constant optical thickness. However, maintaining optical thickness by varying two or more layers in equal-but-opposite directions keeps the response centered about the design wavelength, and provides for the broadest (widest spectral range) response.

1. An optic device comprising:
a multiple layer structure having a substantially constant optical thickness and comprising at least a first layer and a second layer,
the first layer having an optical thickness variable in at least a first direction,
the second layer having an optical thickness variable in at least a second direction, the first direction and the second direction being substantially opposite.

2. The device of claim 1 wherein the first layer has an optical thickness variable in at least the first direction by not greater than one quarter-wave optical thickness.

3. The device of claim 1 wherein the second layer has an optical thickness variable in at least the second direction by not greater than one quarter-wave optical thickness.

4. The device of claim 1 wherein the first layer and the second layer comprise similar material.

5. The device of claim 1 wherein the first layer and the second layer are unequal in amplitude.

6. The device of claim 1 wherein each layer of the multiple layer structure has an index and wherein at least one of the first and second layers has the relatively highest index.

7. The device of claim 1, wherein each layer of the multiple layer structure has an index and wherein at least one of the first and second layers has the relatively lowest index.

8. The device of claim 1, wherein the multiple layer structure comprises a substrate interface, an air interface and a center, and wherein at least one of the first and second layers is located closer to the center than to the substrate interface or the air interface.

9. The device of claim 1, wherein the multiple layer structure comprises a third layer, the third layer having an optical thickness variable in at least one of the first and second directions.

10. The device of claim 1 wherein the optical thickness of at least one of the first layer and the second layer comprises an index of refraction and a physical dimension and at least one of the index of refraction and the physical dimension is variable.

11. The device of claim 1 wherein the first layer and the second layer comprise dissimilar material.

12. The device of claim 1 wherein each layer of the multiple layer structure has an index and wherein at least one of the first and second layers has a relatively higher index than at least some of the layers of the multiple layer structure.

13. The device of claim 1, wherein the multiple layer structure comprises more than two layers having an optical thickness variable in at least one of the first and second directions.

14. The device of claim 1 wherein the first layer has an optical thickness variable in at least a first direction by a first amplitude, the second layer has an optical thickness variable in at least a second direction by a second amplitude, and wherein the first amplitude and the second amplitude are unequal.

15. A method of making an optic device comprising:
forming a multiple layer structure comprising at least a first layer and a second layer,
varying an optical thickness of the first layer in at least a first direction,
varying an optical thickness of the second layer in at least a second direction, the first direction and the second direction being substantially opposite,
maintaining the multiple layer structure at a substantially constant optical thickness.

16. The method of claim 15 comprising varying an optical thickness of the first layer in the first direction by not greater than one quarter-wave optical thickness.

17. The method of claim 15 comprising varying al least one dimension of the second layer in the second direction by not greater than one quarter-wave optical thickness.

18. The method of claim 15 wherein the first layer and the second layer comprise similar material.

19. The method of claim 15 wherein the first layer and the second layer are unequal in amplitude.

20. The method of claim 15 wherein each layer of the multiple layer structure has an index and wherein at least one of the first and second layers has the relatively highest index.

21. The method of claim 15, wherein each layer of the multiple layer structure has an index and wherein at least one of the first and second layers has the relatively lowest index.

22. The method of claim 15, wherein the multiple layer structure comprises a substrate interface, an air interface and a center, and further comprising the step of locating at least one of the first and second layers closer to the center than to the substrate interface or the air interface.

23. The method of claim 15, wherein the multiple layer structure comprises a third layer, the third layer having an optical thickness variable in at least one of the first and second directions.

24. The method of claim 15 wherein the optical thickness of at least one of the first layer and the second layer comprises an index of refraction and a physical dimension and wherein at least one of the steps of varying an optical thickness of the first layer and varying an optical thickness of the second layer comprises varying at least one of the index of refraction and the physical dimension

25. The method of claim 15 wherein the first layer and the second layer comprise dissimilar material.

26. The method of claim 15 wherein each layer of the multiple layer structure has an index and wherein at least one of the first and second layers has a relatively higher index than at least some of the layers of the multiple layer structure.

27. The method of claim 15, wherein the multiple layer structure comprises more than two layers having an optical thickness variable in at least one of the first and second directions.

28. The method of claim 15 wherein the first layer has an optical thickness variable in at least a first direction by a first amplitude, the second layer has an optical thickness variable in at least a second direction by a second amplitude, and wherein the first amplitude and the second amplitude are unequal.

29. A method of controlling phase on at least one of reflectance and transmission in an optic device comprising a multiple layer structure, the method comprising:
varying an optical thickness of at least a first layer in the multiple layer structure in at least a first direction,
varying an optical thickness of a second layer in the multiple layer structure in at least a second direction, the first direction and the second direction being substantially opposite, and
maintaining the multiple layer structure at a substantially constant optical thickness.

30. The method of claim 29 comprising varying an optical thickness of the first layer in the first direction by not greater than one quarter-wave optical thickness.

31. The method of claim 29 comprising varying al least one dimension of the second layer in the second direction by not greater than one quarter-wave optical thickness.

32. The method of claim 29 wherein the first layer and the second layer comprise similar material.

33. The method of claim 29 wherein the first layer and the second layer are unequal in amplitude.

34. The method of claim 29 wherein each layer of the multiple layer structure has an index and wherein at least one of the first and second layers has the relatively highest index.

35. The method of claim 29, wherein each layer of the multiple layer structure has an index and wherein at least one of the first and second layers has the relatively lowest index.

36. The method of claim 29, wherein the multiple layer structure comprises a substrate interface, an air interface and a center, and further comprising the step of locating at least one of the first and second layers closer to the center than to the substrate interface or the air interface.

37. The method of claim 29, wherein the multiple layer structure comprises a third layer, the third layer having an optical thickness variable in at least one of the first and second directions.

38. The method of claim 29 wherein the optical thickness of at least one of the first layer and the second layer comprises an index of refraction and a physical dimension and wherein at least one of the steps of varying an optical thickness of the first layer and varying an optical thickness of the second layer comprises varying at least one of the index of refraction and the physical dimension

39. The method of claim 29 wherein the first layer and the second layer comprise dissimilar material.

40. The method of claim 29 wherein each layer of the multiple layer structure has an index and wherein at least one of the first and second layers has a relatively higher index than at least some of the layers of the multiple layer structure.

41. The method of claim 29, wherein the multiple layer structure comprises more than two layers having an optical thickness variable in at least one of the first and second directions.

42. The method of claim 29 wherein the first layer has an optical thickness variable in at least a first direction by a first amplitude, the second layer has an optical thickness variable in at least a second direction by a second amplitude, and wherein the first amplitude and the second amplitude are unequal.
